(19) United States
(12) Patent Application Publication
(10) Pub. No.: US 2018/0001703 A1
(43) Pub. Date: Jan. 4, 2018

(54) TIRE SIDEWALLS INCLUDING POLYMERIC ORGANOSILICON COMPOUNDS

(71) Applicant: Bridgestone Americas Tire Operations, LLC, Nashville, TN (US)

(72) Inventor: Craig BALNIS, Akron, OH (US)

(21) Appl. No.: 15/536,769

(22) PCT Filed: Dec. 17, 2015
(86) PCT No.: PCT/US2015/066276

§ 371 Date: Jun. 16, 2017

Related U.S. Application Data
(60) Provisional application No. 62/093,019, filed on Dec. 17, 2014.

(51) Int. Cl. B60C 1/00; B60C 13/00; C08L 9/00; C08L 23/16

(52) U.S. Cl. CPC B60C 1/0025; C08L 23/16; B60C 13/00; C08L 9/00

(57) ABSTRACT

A tire sidewall comprising a vulcanized rubber and a polymeric organo silicon compound.

This application claims the benefit of U.S. Provisional Patent Application Ser. No. 62/093,019, filed on Dec. 17, 2014, which is incorporated herein by reference.

### FIELD OF THE INVENTION

Embodiments of the present invention are directed toward tire sidewalls including polymeric organosilicon compounds.

### BACKGROUND OF THE INVENTION

The art of making tire sidewalls presents unique challenges. In particular, tire sidewalls are susceptible to ozone tack, and when combined with prolonged static and dynamic stresses, cracks and fissures occur. These cracks are typically oriented substantially perpendicular to the direction of the stress, and their propagation under persistent stress can be aesthetically problematic and can even be deleterious to the tire itself.

Conventional technology includes the use of antidegradants that inhibit ozone degradation and thereby slow the formation of cracks. The use of antidegradants, such as antiozonants, has nonetheless been found to have a deleterious impact on the aesthetics of the tire sidewall. In particular, antiozonants migrate to the surface of the sidewall and leave an unattractive residue or otherwise stain the sidewall.

Therefore, there is a desire to overcome the problems associated with the undesirable aesthetic impact of antiozonants while maintaining resistance to ozone attack.

### SUMMARY OF THE INVENTION

One or more embodiments of this invention provide a tire sidewall comprising a vulcanized rubber and a polymeric organosilicon compound.

Still other embodiments of this invention provide a tire comprising of a sidewall including a vulcanized rubber with reinforcing filler, antiozonant, and at least 0.0025 and at most 2.0 parts by weight polymeric organosilicon compound per 100 parts by weight rubber dispersed within said vulcanized rubber.

Still yet other embodiments of this invention provide a method for preparing a tire sidewall, the method comprising of vulcanizing a green tire sidewall, said green tire sidewall being fabricated from a vulcanizable composition of matter comprising a rubber, from about 5 to about 200 parts by weight filler per 100 parts by weight rubber, from about 0.0025 to about 2.0 parts by weight of a polymeric organosilicon compound per 100 parts by weight rubber, from about 2.0 to about 10 parts by weight antiozonant per 100 parts by weight rubber, and a curative.

### BRIEF DESCRIPTION OF THE DRAWINGS

FIG. 1 is a cross-sectional view of a tire according to one or more embodiments of this invention.

### DETAILED DESCRIPTION OF ILLUSTRATIVE EMBODIMENTS

Embodiments of the invention are based, at least in part, on the discovery of a tire sidewall that includes a polymeric organosilicon compound. These sidewalls are characterized by desirable color and appreciable gloss. In fact, while it has been observed that the presence of polymeric organosilicon compounds within a sidewall can have a deleterious impact on sidewall ozone-induced crack growth resistance, it has unexpectedly been found that gloss improvement can be achieved at very low loadings of the polymeric organosilicon compound. As a result, an advantageous balance between gloss improvement and crack growth resistance can be achieved. And, in certain embodiments, it has unexpectedly been observed that sidewalls exhibiting high gloss and technologically useful resistance to crack growth can be prepared where the rubber component of the sidewall includes an olefinic rubber, such as ethylene-propylene-diene rubber (EPDM). In fact, it is believed that the combination of olefinic rubber and polymeric organosilicon may provide a synergistic effect, especially at relatively low loadings of the polymeric organosilicon compound.

### Tire Configuration

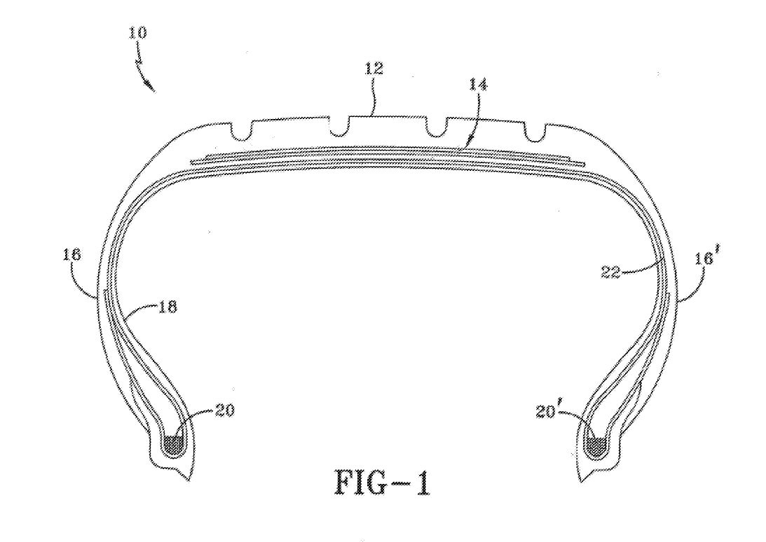

An example of a tire according to the present invention is shown in FIG. 1, where tire 10 includes a tread portion 12, a belt package 14, a pair of sidewalls 16, 16′ an inner liner 18, and a pair of axially spaced bead portions 20. Ply 22 extends between bead portions 20, 20′. In one or more embodiments, sidewalls 16, 16′ are formed from sidewall compositions according to aspects of the present invention.

### Sidewall Composition

As indicated above, sidewalls of the present invention are prepared from vulcanizable compositions of matter, which may also be referred to as a tire sidewall compound, that include a polymeric organosilicon compound. In one or more embodiments, vulcanizable compositions used to prepare the sidewalls otherwise include conventional ingredients. For example, in one or more embodiments, the sidewall compounds of the present invention include an elastomer, a filler, a curative, and an antidegradant. Other optional ingredients may include cure activators, cure accelerators, oils, resins, plasticizers, pigments, fatty acids, zinc oxide, and peptizing agents.

### Rubber

In one or more embodiments, the rubber, which may also be referred to as a vulcanizable rubber or elastomer, may include those polymers that can be vulcanized to form compositions possessing rubbery or elastomeric properties. These elastomers may include natural and synthetic rubbers. The synthetic rubbers typically derive from the polymerization of conjugated diene monomer, the copolymerization of conjugated diene monomer with other monomer such as vinyl-substituted aromatic monomer, or the copolymerization of ethylene with one or more α-olefins and optionally one or more diene monomers.

Exemplary elastomers include natural rubber, synthetic polyisoprene, polybutadiene, polyisobutylene-co-isoprene, neoprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star-shaped structures. These elastomers may also include one or more functional units, which typically include heteroatoms. In particular embodiments, the sidewall compounds of the present invention include a blend of natural rubber and synthetic diene rubber such as polybutadiene. In other embodiments, the sidewall compounds of the present invention include olefinic rubber such ethylene-propylene-diene rubber (EPDM).

### Filler

The filler may include one or more conventional reinforcing or non-reinforcing fillers. For example, useful fillers include carbon black, silica, alumina, and silicates such as calcium, aluminum, and magnesium silicates.

In one or more embodiments, carbon blacks include furnace blacks, channel blacks, and lamp blacks. More specific examples of carbon blacks include super abrasion furnace (SAF) blacks, intermediate super abrasion furnace (ISAF) blacks, high abrasion furnace (HAF) blacks, fast extrusion furnace (FEF) blacks, fine furnace (FF) blacks, semi-reinforcing furnace (SRF) blacks, medium processing channel blacks, hard processing channel blacks, conducting channel blacks, and acetylene blacks. Representative carbon blacks useful in one or more embodiments may include those designated by ASTM D1765 as N326, N330, N339, N343, N347, N351, N358, N550, N650, N660, N762, N772, and N774.

In particular embodiments, the carbon blacks may have a surface area (EMSA) of at least 20 m²/g, in other embodiments at least 35 m²/g, in other embodiments at least 50 m²/g, in other embodiments at least 60 m²/g; surface area values can be determined by ASTM D-1765 using the cetyltrimethylammonium bromide (CTAS) technique. In particular embodiments, the sidewalls include carbon black filler having a surface area (EMSA) of from about 60 to about 110 m²/g. The carbon blacks may be in a pelletized form or an unpelletized flocculent form. The preferred form of carbon black may depend upon the type of mixing equipment used to mix the rubber compound.

In one or more embodiments, the filler may include silica. When silica is used as a filler, the silica may be employed in conjunction with a coupling agent. In these or other embodiments, the silica may be used in conjunction with a silica dispersing agent.

In one or more embodiments, useful silicas include, but are not limited to, precipitated amorphous silica, wet silica (hydrated silicic acid), dry silica (anhydrous silicic acid), fumed silica, calcium silicate, and the like. Other suitable fillers include aluminum silicate, magnesium silicate, and the like. In particular embodiments, the silica is a precipitated amorphous wet-processed hydrated silica. In one or more embodiments, these silicas are produced by a chemical reaction in water, from which they are precipitated as ultra-fine, spherical particles. These primary particles are believed to strongly associate into aggregates, which in turn combine less strongly into agglomerates.

Some commercially available silicas that may be used include Hi-Sil™ 215, Hi-Sil™ 233, and Hi-Sil™ 190 (PPG Industries, Inc.; Pittsburgh, Pa.). Other suppliers of commercially available silica include Grace Davison (Baltimore, Md.), Degussa Corp. (Parsippany, N.J.), Rhodia Silica Systems (Cranbury, N.J.), and J.M. Huber Corp. (Edison, N.J.).

In one or more embodiments, silicas may be characterized by their surface areas, which give a measure of their reinforcing character. The Brunauer, Emmet and Teller (“BET”) method (described in J. Am. Chem. Soc., vol. 60, p. 309 et seq.) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g.

In one or more embodiments, the pH of silica may be from about 5 to about 7 or slightly over 7, or in other embodiments from about 5.5 to about 6.8.

In one or more embodiments, useful silica coupling agents include sulfur-containing silica coupling agents. Examples of sulfur-containing silica coupling agents include bis(trialkoxysilylorgano)polysulfides or mercapto-organoalkoxysilanes. Types of bis(trialkoxysilylorgano)polysulfides include bis(trialkoxysilylorgano)disulfide and bis(trialkoxysilylorgano)tetrasulfides. Exemplary silica dispersing aids include, but are not limited to an alkyl alkoxysilane, a fatty acid ester of a hydrogenated or non-hydrogenated C₅ or C₆ sugar, a polyoxyethylene derivative of a fatty acid ester of a hydrogenated or non-hydrogenated C₅ or C₆sugar, and mixtures thereof, or a mineral or non-mineral additional filler.

### Curative

A multitude of rubber curing agents (also called vulcanizing agents) may be employed, including sulfur or peroxide-based curing systems. Curing agents are described in Kirk-Othmer, ENCYCLOPEDIA OF CHEMICAL TECHNOLOGY, Vol. 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2^{nd} Ed. 1989), which are incorporated herein by reference. In one or more embodiments, the curative is sulfur. Examples of suitable sulfur vulcanizing agents include “rubberrmaker's” soluble sulfur; sulfur donating vulcanizing agents, such as an amine disulfide, polymeric polysulfide or sulfur olefin adducts; and insoluble polymeric sulfur. Vulcanizing agents may be used alone or in combination.

In one or more embodiments, the curative is employed in combination with a cure accelerator. In one or more embodiments, accelerators are used to control the time and/or temperature required for vulcanization and to improve properties of the vulcanizate. Examples of accelerators include thiazol vulcanization accelerators, such as 2-mercaptobenzothiazol, dibenzothiazyl disulfide, N-cyclohexyl-2-benzothiazyl-sulfenamide (CBS), and the like, and guanidine vulcanization accelerators, such as diphenylguanidine (DPG) and the like.

### Antidegradants

In one or more embodiments, the antidegradants may include antioxidants, antiozonants, and waxes. In particular embodiments, the sidewall compounds of this invention include at least one of an antioxidant, an antiozonant, and a wax. In one or more embodiments, the sidewall compounds include an antioxidant, an antiozonant, and a wax.

In one or more embodiments, useful antioxidants include substituted phenols, diphenyl amine-acetone reaction products, 2,2,2-trimethyl-1,2-dihydroquinoline polymer (TMQ), and tri(nonophenyl)phosphite.

In one or more embodiments, useful antiozonants include amines such as N,N-disubstituted-p-phenylene diamines. These diamines may include both symmetrical and asymmetrical compounds. Useful symmetrical diamines include N,N-dialkyl-p-phenylene diamine. Useful asymmetrical diamines include N-alkyl, N′-aryl-p-phenylene diamines such as N-(1,3-dimethylbutyl)-N′-phenyl-p-phenylene diamine (6PPD) and N-isopropyl-N′-phenyl-p-phenylene diamine.

In one or more embodiments, useful waxes include paraffinic waxes and microcrystalline waxes. Useful waxes include those having a molecular weight of from about 100 to about 1000 g/mole, in other embodiments from about 300 to about 800 g/mole, and in other embodiments from about 400 to about 700 g/mole.

### Polymeric Organosilicon

In one or more embodiments, polymeric organosilicon compounds, which may also be referred to as silicones or polydialkylsiloxanes, include silicon-based organic polymers. In one or more embodiments, useful polydiaklylsiloxanes include those compounds including repeat units defined by the formula

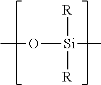

where each R is independently a monovalent organic group.

In one or more embodiments, the monovalent organic groups may be hydrocarbyl groups or substituted hydrocarbyl groups such as, but not limited to, alkyl, cycloalkyl, alkenyl, cycloalkenyl, aryl, allyl, aralkyl, alkaryl, or alkynyl groups. Substituted hydrocarbyl groups include hydrocarbyl groups in which one or more hydrogen atoms have been replaced by a substituent such as a hydrocarbyl, hydrocarbyloxy, silyl, or siloxy group. In one or more embodiments, these groups may include from one, or the appropriate minimum number of carbon atoms to form the group, to about 20 carbon atoms. These groups may also contain heteroatoms such as, but not limited to, nitrogen, boron, oxygen, silicon, sulfur, tin, and phosphorus atoms. In particular embodiments, each R is methyl, and therefore the polymeric organosilicon compound is polydimethylsiloxane (PDMS).

In one or more embodiments, the polymeric organosilicon compound is a polydimethylsiloxane having a molecular weight of at least 200 g/mole, in other embodiments at least 1,250 g/mole, and in other embodiments at least 2000 g/mole. In these or other embodiments, the polydimethylsiloxane may have a molecular weight of at most 28,000, in other embodiments at most 24,000, and in other embodiments at most 19,000 g/mole. In one or more embodiments, the polydimethylsiloxane may have a molecular weight of from about 200 to about 28,000, in other embodiments from about 1,250 to about 24,000, and in other embodiments from about 2,000 to about 19,000 g/mole.

In one or more embodiments, the polymeric organosilicon compounds are dialkyl silicon oils, which refers to the fact that the polymeric organosilicon compounds are liquids at room temperature. In one or more embodiments, these silicon oils may be characterized by a viscosity, as measured by using a Brookfield viscometer, of at most 1000 cSt, in other embodiments at most 800 cSt, and in other embodiments at most 600 cSt. In these or other embodiments, the polydimethylsiloxane may characterized by a viscosity of at least 1 cSt, in other embodiments at least 10 cSt, and in other embodiments at least 20 cSt. In one or more embodiments, the polydimethylsiloxane may be characterized by a viscosity of from about 1 to about 1000 cSt, in other embodiments from about 10 to about 800 cSt, and in other embodiments from about 20 to about 600 cSt.

### Other Ingredients

Other ingredients that are typically employed in rubber compounding may also be added to the rubber compositions. These include oils, plasticizers, waxes, scorch inhibiting agents, processing aids, zinc oxide, tackifying resins, reinforcing resins, fatty acids such as stearic acid, and peptizers. In particular embodiments, the oils that are employed include those conventionally used as extender oils, which are described above. Useful oils or extenders that may be employed include, but are not limited to, aromatic oils, paraffinic oils, naphthenic oils, vegetable oils other than castor oils, low PCA oils including MES, TDAE, and SRAE, and heavy naphthenic oils.

### Ingredient Amounts

### Rubber

In one or more embodiments, the vulcanizable compositions include at least 20, in other embodiments at least 30, and in other embodiments at least 40 percent by weight of the rubber component, based upon the entire weight of the composition. In these or other embodiments, the vulcanizable compositions include at most 90, in other embodiments at most 70, and in other embodiments at most 60 percent by weight of the rubber component based on the entire weight of the composition. In one or more embodiments, the vulcanizable compositions include from about 20 to about 90, in other embodiments from about 30 to about 70, and in other embodiments from about 40 to about 60 percent by weight of the rubber component based upon the entire weight of the composition.

As suggested above, in certain embodiments of the invention, the rubber component includes (an in certain embodiments consists of) natural rubber and a synthetic diene rubber (e.g. polybutadiene). In one or more of these embodiments, the weight ratio of natural rubber to synthetic diene rubber may be from 0.4:1 to 1.5:1, in other embodiments from 0.6:1 to 1.3:1, and in other embodiments from 0.8:1 to 1.2:1.

### Filler

In one or more embodiments, the vulcanizable compositions include at least 5, in other embodiments at least 25, and in other embodiments at least 40 parts by weight (pbw) filler (e.g. carbon black) per 100 parts by weight rubber (phr). In these or other embodiments, the vulcanizable composition includes at most 200, in other embodiments at most 120, and in other embodiments at most 70 pbw of the filler phr. In one or more embodiments, the vulcanizable composition includes from about 5 to about 200, in other embodiments from about 25 to about 120, and in other embodiments from about 40 to about 70 pbw of filler phr.

### Antidegradants

In one or more embodiments, the vulcanizable compositions of this invention include at least 5, in other embodiments at least 6, in other embodiments at least 7 parts by weight (pbw) total antidegradant (e.g. antioxidant, antiozonant, and wax) per 100 parts by weight rubber (phr). In these or other embodiments, the vulcanizable composition includes at most 20, in other embodiments at most 15, and in other embodiments at most 12 pbw total antidegradant phr. In one or more embodiments, the vulcanizable composition includes from about 5 to about 20, in other embodiments from about 6 to about 15, and in other embodiments from about 7 to about 12 pbw total antidegradant phr.

In these or other embodiments, the vulcanizable compositions include at least 2.0, in other embodiments at least 2.2, in other embodiments at least 2.4, in other embodiments at least 2.6, in other embodiments at least 2.8, and in other embodiments at least 3.0 parts by weight (pbw) antioxidant (e.g. TMQ) per 100 parts by weight rubber (phr). In these or other embodiments, the vulcanizable composition includes at most 10, in other embodiments at most 8, and in other embodiments at most 6 pbw of antioxidant phr. In one or more embodiments, the vulcanizable composition includes from about 2.0 to about 10, in other embodiments from about 2.2 to about 8, and in other embodiments from about 2.4 to about 6 pbw of antioxidant phr.

In these or other embodiments, the vulcanizable compositions include at least 2.0, in other embodiments at least 2.2, in other embodiments at least 2.4, in other embodiments at least 2.6, in other embodiments at least 2.8, and in other embodiments at least 3.0 parts by weight (pbw) antiozonant (e.g. 6PPD) per 100 parts by weight rubber (phr). In these or other embodiments, the vulcanizable composition includes at most 10, in other embodiments at most 8, and in other embodiments at most 6 pbw of antiozonant phr. In one or more embodiments, the vulcanizable composition includes from about 2.0 to about 10, in other embodiments from about 2.2 to about 8, and in other embodiments from about 2.4 to about 6 pbw of antiozonant phr.

In these or other embodiments, the vulcanizable compositions include at least 2.0, in other embodiments at least 2.2, in other embodiments at least 2.4, in other embodiments at least 2.6, in other embodiments at least 2.8, and in other embodiments at least 3.0 parts by weight (pbw) wax per 100 parts by weight rubber (phr). In these or other embodiments, the vulcanizable composition includes at most 10, in other embodiments at most 8, and in other embodiments at most 6 pbw of wax phr. In one or more embodiments, the vulcanizable composition includes from about 2.0 to about 10, in other embodiments from about 2.2 to about 8, and in other embodiments from about 2.4 to about 6 pbw of wax phr.

### Polymeric Organosilicon

In one or more embodiments, the vulcanizable compositions include at least 0.0025, in other embodiments at least 0.0075, in other embodiments at least 0.01, in other embodiments at least 0.03, in other embodiments at least 0.05, in other embodiments at least 0.08, in other embodiments at least 0.1, and in other embodiments at least 0.15 parts by weight (pbw) polymeric organosilicon (e.g. PDMS) per 100 parts by weight rubber (phr). In these or other embodiments, the vulcanizable composition includes at most 2.0, in other embodiments at most 1.0, in other embodiments at most 0.8, in other embodiments at most 0.6, in other embodiments at most 0.4, in other embodiments at most 0.2, and in other embodiments at most 0.1 pbw of polymeric organosilicon phr. In one or more embodiments, the vulcanizable composition includes from about 0.0025 to about 2.0, in other embodiments from about 0.1 to about 1.0, and in other embodiments from about 0.05 to about 0.5 pbw polymeric organosilicon phr.

### Cure System

The skilled person will be able to readily select the amount of vulcanizing agents to achieve the level of desired cure. Also, the skilled person will be able to readily select the amount of cure accelerators to achieve the level of desired cure.

### Mixing Procedure

All ingredients of the rubber compositions can be mixed with standard mixing equipment such as Banbury or Brabender mixers, extruders, kneaders, and two-rolled mills. As suggested above, the ingredients are mixed in two or more stages. In the first stage (i.e., mixing stage), which typically includes the rubber component and filler, is prepared. To prevent premature vulcanization (also known as scorch), vulcanizing agents. Once the masterbatch is prepared, the vulcanizing agents may be introduced and mixed into the masterbatch in a final mixing stage, which is typically conducted at relatively low temperatures so as to reduce the chances of premature vulcanization. Additional mixing stages, sometimes called remills, can be employed between the masterbatch mixing stage and the final mixing stage.

### Preparation of Tire

The compositions can be processed into tire components according to ordinary tire manufacturing techniques including standard rubber shaping, molding and curing techniques. Typically, vulcanization is effected by heating the vulcanizable composition in a mold; e.g., it may be heated to about 140° C. to about 180° C. Cured or crosslinked rubber compositions may be referred to as vulcanizates, which generally contain three-dimensional polymeric networks that are thermoset. The other ingredients, such as the polymeric organosilicon, as well as the fillers and processing aids, may be evenly dispersed throughout the crosslinked network. In particular embodiments, one or more of the compound ingredients may become crosslinked or otherwise chemically bonded to the crosslinked rubber network. As the skilled person will appreciate, the amounts of the various ingredients, especially those that do not react, will remain within the cured tire component the same as they existed within the compound.

Pneumatic tires can be made as discussed in U.S. Pat. Nos. 5,866,171, 5,876,527, 5,931,211, and 5,971,046, which are incorporated herein by reference. For example, the various tire components can be prepared as green tire components (i.e., uncured tire components), and assembled into a green tire. The green tire can then be subjected to curing conditions to form a vulcanized tire wherein the various green components are generally adhered to one another through the vulcanization process.

### Characteristics of Tire Sidewall

In one or more embodiments, the tire sidewalls of the present invention are characterized by an advantageous balance of properties. In particular embodiments, the tire sidewalls are characterized by an advantageous balance between resistance to dynamically-strained ozone-induced crack growth and an advantageous color.

In one or more embodiments, ozone resistance, which for purposes of this specification may refer to resistance to dynamically-strained ozone-induced crack formation, may be determined quantitatively ASTM D-1149.

In combination therewith, in one or more embodiments, color can be quantified by using a spectrophotometer device, which reports measurements in the CIE LAB color space as recognized by the International Commission on Illumination. For example, color and gloss may be determined by using a Minolta CM2600D Spectrophotometer, calibrated according to the manufacturer's standards. For the static ozone testing, samples are typically exposed to 100 parts ozone per hundred million air at a temperature of 60° C.+1° C. for 7 days while statically strained. For this purpose, an ozone box, OREC model 0500/DM100 and ozone monitor,® OREC model O3DM100 may be employed. The measurements, L, a, and b, describe 3 axes, and identify a unique color. The vector difference between two colors, dE, can be calculated as follows:

dE=V((L1−L2)2+(a1−a2)2+(b b2)2)

Gloss is defined as the spectral reflectance produced by light hitting a surface, and can be expressed as the vectoral difference between the absolute color spectral component included of an object and the color reflected from its surface at a 10° angle.

The skilled person recognizes that positive b* is indicative of yellow, which is believed to be attributable to antiozonants (such as 6PPD), and therefore a lower positive b* is desired. In one or more embodiments, the b* of the tire sidewalls of the present invention is greater than 0 and, in these or other embodiments, lower than 4, in other embodiments lower than 3, and in other embodiments lower than 2.

Various modifications and alterations that do not depart from the scope and spirit of this invention will become apparent to those skilled in the art. This invention is not to be duly limited to the illustrative embodiments set forth herein.

1. A tire sidewall comprising:
a. a vulcanized rubber; and
b. a polymeric organosilicon compound.

2. The tire of claim 1, where the sidewall includes at least 0.0025 parts by weight and at most 2.0 parts by weight polymeric organosilicon compound per 100 parts by weight rubber.

3. The tire of claim 1, where the sidewall includes at least 0.0075 parts by weight and at most 1.0 parts by weight polymeric organosilicon compound per 100 parts by weight rubber.

4. The tire of claim 1, further comprising at least 5 parts by weight antidegradant per 100 parts by weight rubber.

5. The tire of claim 1, further comprising at least 2.0 parts by weight antioxidant per 100 parts by weight rubber.

6. The tire of claim 1, further comprising at least 2.0 parts by weight antiozonant per 100 parts by weight rubber.

7. The tire of claim 1, further comprising at least 2.0 parts by weight wax per 100 parts by weight rubber.

8. The tire of claim 1, where the vulcanized rubber includes the vulcanized product of natural rubber and a synthetic polydiene.

9. The tire of claim 1, where the vulcanized rubber includes the vulcanized product of ethylene-propylene-diene rubber.

10. The tire of claim 1, where the polymeric organosilicon compound is a polydialkylsiloxane.

11. The tire of claim 1, where the polymeric organosilicon compound is a polydimethylsiloxane.

12. The tire of claim 1, where the polymeric organosilicon compound is a silicone oil.

13. The tire of claim 1, where the silicone oil has a molecular weight of at most 28,000 g/mol.

14. The tire of claim 1, where the silicone oil is characterized by a viscosity of from about 1 to about 1,000 cSt.

15. The tire sidewall of claim 1, where the polymeric organosilicon compound is dispersed throughout said vulcanized rubber.

16. A tire comprising:
a sidewall including a vulcanized rubber with reinforcing filler, antiozonant, and
at least 0.0025 and at most 2.0 parts by weight polymeric organosilicon compound per 100 parts by weight rubber dispersed within said vulcanized rubber.

17. (canceled)

18. The tire of claim 16, where the polymeric organosilicon compound is a polydimethylsiloxane.

19. The tire of claim 16, where the polymeric organosilicon compound is a silicone oil.

20. The tire of claim 16, where the silicone oil is characterized by a molecular weight of from about 1,250 to about 24,000 g/mol.

21. (canceled)

22. A method for preparing a tire sidewall, the method comprising:
vulcanizing a green tire sidewall, said green tire sidewall being fabricated from a vulcanizable composition of matter comprising a rubber, from about 5 to about 200 parts by weight filler per 100 parts by weight rubber, from about 0.0025 to about 2.0 parts by weight of a polymeric organosilicon compound per 100 parts by weight rubber, from about 2.0 to about 10 parts by weight antiozonant per 100 parts by weight rubber, and a curative.
